(19) United States
(12) Patent Application Publication
(10) Pub. No.: US 2023/0363600 A1
(43) Pub. Date: Nov. 16, 2023

(54) ROBOT CLEANER

(71) Applicant: Samsung Electronics Co., Ltd., Suwon-si (KR)

(72) Inventors: Seokman HONG, Suwon-si (KR); Yunsoo JANG, Suwon-si (KR); Dokyung LEE, Suwon-si (KR)

(21) Appl. No.: 18/359,315

(22) Filed: Jul. 26, 2023

Related U.S. Application Data
(63) Continuation of application No. PCT/KR2022/004366, filed on Mar. 29, 2022.

(30) Foreign Application Priority Data
Apr. 23, 2021 (KR) 10-2021-0052850
Jun. 9, 2021 (KR) 10-2021-0074536

(51) Int. Cl. A47L 9/16; A47L 9/28; A47L 9/12; A47L 9/14; B04C 3/06; B04C 9/00

(52) U.S. Cl. CPC A47L 9/1683; A47L 9/1608; A47L 9/2873; A47L 9/122; A47L 9/165; A47L 9/149; A47L 9/1409; B04C 3/06; B04C 9/00; A47L 2201/022; A47L 2201/024; B04C 2009/002; B04C 2009/005

(57) ABSTRACT

A robot cleaner is provided. The robot cleaner includes a main body including a suction device configured to intake dust and a dust container detachably mounted on the main body and configured to separate and store dust from air intaken by the suction device, wherein the dust container includes a first chamber configured to separate and store dust from air introduced from the suction device, a second chamber configured to separate and store dust from air introduced from the first chamber, a dust collecting cover configured to filter dust in air introduced from the first chamber into the second chamber, and an airflow guide disposed on an upper portion of the dust collecting cover and configured to guide air flowing above the upper portion of the dust collecting cover toward the second chamber.

### CROSS-REFERENCE TO RELATED APPLICATION(S)

This application is a continuation application, claiming priority under § 365(c), of an International application No. PCT/KR2022/004366, filed on Mar. 29, 2022, which is based on and claims the benefit of a Korean patent application number 10-2021-0052850, filed on Apr. 23, 2021, in the Korean Intellectual Property Office, and of a Korean patent application number 10-2021-0074536, filed on Jun. 9, 2021, in the Korean Intellectual Property Office, the disclosure of each of which is incorporated by reference herein in its entirety.

### BACKGROUND

### 1. Field

The disclosure relates to a robot cleaner. More particularly, the disclosure relates to a robot cleaner including a dust container having an improved structure.

### 2. Description of Related Art

In general, robot cleaners are apparatuses that move around a cleaning area without manipulation by a user, and intake foreign matter, such as dust accumulated on a floor, thereby automatically cleaning the cleaning area. The robot cleaners may clean the cleaning area while autonomously traveling around the cleaning area.

A robot cleaner may clean a cleaning area by determining a distance to obstacles, such as furniture, office supplies, and walls installed in the cleaning area through a distance sensor, and changing a traveling direction automatically while selectively driving left and right wheel motors of the robot cleaner.

For example, a recent robot cleaner may include an automatic dust discharge mode in which a docking station automatically discharges dust from a dust container of the robot cleaner when a main body is docked to the docking station.

However, when the automatic dust discharge mode is performed, dust inside the dust container may not be discharged due to various reasons. For example, dust accumulated at a certain position inside the dust container may not be discharged due to backflow occurring inside the dust container.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a robot cleaner with improved dust discharge efficiency.

Another aspect of the disclosure is to provide a robot cleaner capable of minimizing residual dust inside a dust container.

Another aspect of the disclosure is to provide a robot cleaner with improved usability.

Additional aspects will be set forth in part in the description which follows and, in part, will be apparent from the description, or may be learned by practice of the presented embodiments.

In accordance with an aspect of the disclosure, a robot cleaner is provided. The robot cleaner includes a main body including a suction device configured to intake dust and a dust container detachably mounted on the main body and configured to separate and store dust from air intaken by the suction device, wherein the dust container includes a first chamber configured to separate and store dust from air introduced from the suction device, a second chamber configured to separate and store dust from air introduced from the first chamber, a dust collecting cover configured to filter dust in air introduced from the first chamber into the second chamber, and an airflow guide disposed on an upper portion of the dust collecting cover and configured to guide air flowing above the upper portion of the dust collecting cover toward the second chamber.

The airflow guide may be located closer to the suction device than a point of ½ of a width of the dust container in a front-to-back direction.

The first chamber and the second chamber may be arranged side by side in a left-right direction.

The dust collecting cover further includes a first cover configured to cover an upper surface of the first chamber, and a second cover extending downwardly from the first cover and configured to cover one side of the first chamber facing the second chamber.

The first cover of the dust collecting cover includes at least one bent portion to increase a surface area of the dust collecting cover.

The dust collecting cover includes at least one of a grille and a mesh.

The robot cleaner further includes a cyclone separator disposed in the second chamber and configured to separate dust in air introduced into the second chamber by using centrifugal force of a vortex, and wherein the cyclone separator includes a cyclone inlet disposed on a side surface of the cyclone separator to allow air to flow into the cyclone separator, a cyclone dust outlet disposed on a lower surface of the cyclone separator to allow dust separated from air introduced into the cyclone inlet to be discharged, and a cyclone outlet disposed on an upper surface of the cyclone separator to allow dust-separated air after being introduced into the cyclone inlet to be discharged.

The dust container further includes a case having an open upper surface and an open lower surface and configured to form the first chamber and the second chamber, an upper cover configured to cover the open upper surface of the case, and a lower cover configured to cover the open lower surface of the case and including a dust outlet for discharging dust stored in the first chamber and the second chamber.

The airflow guide may be integrally formed with the upper cover, and configured to partition a space between the dust collecting cover and the upper cover to form a guide passage.

The airflow guide may extend in a left-right direction.

The second chamber further includes a dust separation chamber into which air passing through a dust collecting chamber is introduced, and a dust storage chamber partitioned from the dust separation chamber and disposed at a lower portion of the dust separation chamber to store dust separated from the air passing through the dust collecting chamber in the dust separation chamber.

The dust container further includes a first dust outlet disposed at a lower portion of the first chamber to allow dust in the first chamber to be discharged, a second dust outlet disposed at a lower portion of the second chamber to allow dust in the second chamber to be discharged, and an outlet door configured to open and close the first dust outlet and the second dust outlet.

The robot cleaner further includes a docking station configured to seat the main body, and the docking station may charge a battery mounted inside the main body and automatically discharge dust stored in the dust container.

In accordance with another aspect of the disclosure, a robot cleaner is provided. The robot cleaner includes a main body, a suction device configured to intake dust into the main body, and a dust container configured to separate and store air intaken by the suction device, wherein the dust container includes a case, an upper cover configured to cover an upper surface of the case, a first chamber located inside the case and configured to separate and store dust from air introduced from the suction device, a second chamber arranged side by side in a left-right direction with the first chamber and including a cyclone device configured to separate dust from air introduced from the first chamber, a dust collecting cover arranged between the first chamber and the second chamber and configured to filter dust in air introduced into the first chamber, and an airflow guide configured to guide air introduced into a space between the dust collecting cover and the upper cover by colliding with an inner wall of the case in the first chamber to the second chamber.

The airflow guide may be located closer to the suction device than a point of ½ of a width of the dust container in a front-to-back direction.

The main body may a pair of wheels travelling along a floor and the dust container may detachably mounted between the pair of wheels of the main body.

The airflow guide includes at least one of a hole and a slot to prevent air from remaining between the dust collecting cover and the upper cover.

The air flow guide may extend from a lower surface of the upper cover and have a shape corresponding to the dust collecting cover.

The dust collecting cover further includes a bent portion to increase a surface area of the dust collecting cover, and the airflow guide further includes a protrusion configured to engage with the bent portion.

In accordance with another aspect of the disclosure, a robot cleaner is provided. The robot cleaner includes a suction device configured to intake dust and a dust container configured to separate and store dust from air intaken by the suction device, wherein the dust container includes a first chamber configured to separate and store dust from air introduced from the suction device, a second chamber arranged side by side in a first direction with the first chamber and configured to separate and store dust from air introduced from the first chamber, a dust collecting cover configured to filter dust in air introduced from the first chamber into the second chamber, and an airflow guide configured to guide air flowing above an upper portion of the dust collecting cover toward the second chamber to prevent dust from accumulating on the upper portion of the dust collecting cover.

According to the spirit of the disclosure, the dust discharge efficiency of the robot cleaner can be improved.

According to the spirit of the disclosure, the robot cleaner can minimize residual dust in the dust container.

According to the spirit of the disclosure, the convenience of use of the robot cleaner can be improved.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a robot cleaner according to an embodiment of the disclosure;

FIG. 2 is an exploded view of the robot cleaner shown in FIG. 1 according to an embodiment of the disclosure;

FIG. 3 is a side cross-sectional view of the robot cleaner shown in FIG. 1 according to an embodiment of the disclosure;

FIG. 4 is a view illustrating a dust container of the robot cleaner shown in FIG. 2 according to an embodiment of the disclosure;

FIG. 5 is an exploded view of the dust container shown in FIG. 4 according to an embodiment of the disclosure;

FIG. 6 is a view illustrating an airflow guide of the dust container shown in FIG. 4 according to an embodiment of the disclosure;

FIG. 7 is a view of the inside of the dust container shown in FIG. 4 according to an embodiment of the disclosure;

FIG. 8 is a cross-sectional view of the dust container shown in FIG. 4 according to an embodiment of the disclosure;

FIG. 9 is a cross-sectional view of the dust container shown in FIG. 4 according to an embodiment of the disclosure;

FIG. 10 is a plan view of the dust container shown in FIG. 4 according to an embodiment of the disclosure;

FIG. 11 is a view illustrating an inside of the dust container of part A shown in FIG. 10 according to an embodiment of the disclosure;

FIG. 12 is a view illustrating a state in which upper and lower covers of the dust container shown in FIG. 4 are opened according to an embodiment of the disclosure;

FIG. 13 is a view illustrating a state in which a discharge port door of the dust container shown in FIG. 4 is opened according to an embodiment of the disclosure;

FIG. 14 is a view illustrating an airflow guide of a robot cleaner according to an embodiment of the disclosure according to an embodiment of the disclosure;

FIG. 15 is a view illustrating an airflow guide of a robot cleaner according to an embodiment of the disclosure according to an embodiment of the disclosure; and

FIG. 16 is a view illustrating a state in which the robot cleaner shown in FIG. 1 is seated in a docking station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, the same reference numerals or signs shown in the drawings of the disclosure indicate elements or components performing substantially the same function.

In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “upper side”, “lower side” and “front-rear direction” may be defined by the drawings, but the shape and the location of the component is not limited by the term.

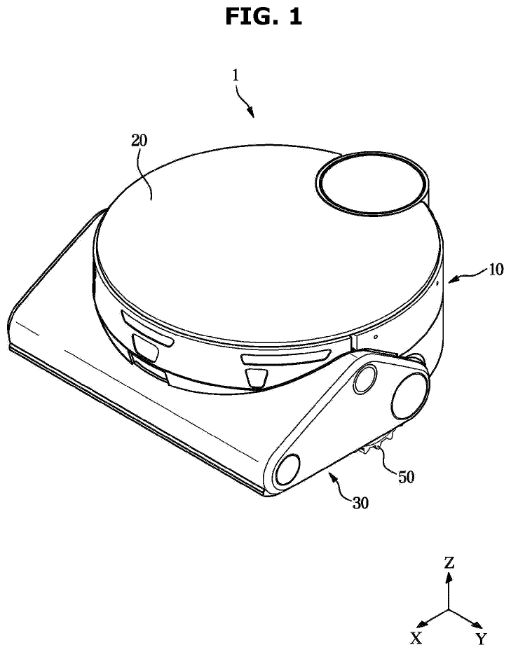

Hereinafter, various embodiments according to the disclosure will be described in detail with reference to the accompanying drawings. Referring to FIGS. 1 to 3, forward and backward directions may be defined based on the X direction, left and right directions may be defined based on the Y direction, and up and down directions may be defined based on the Z direction. For example, based on a dust container 100, a direction toward a suction device 30 may be defined as a front, and a direction toward a battery 40 may be defined as a rear. However, the shape and location of each component is not limited by the terms so defined.

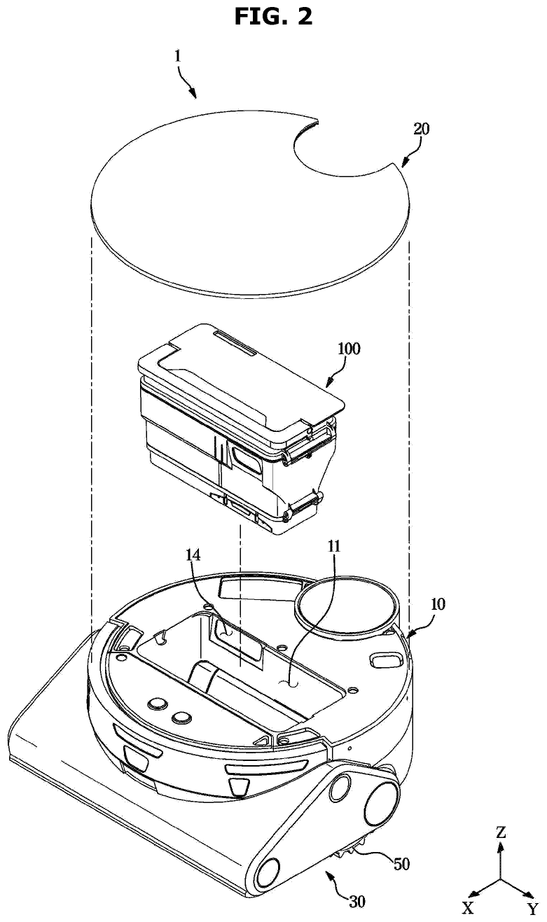

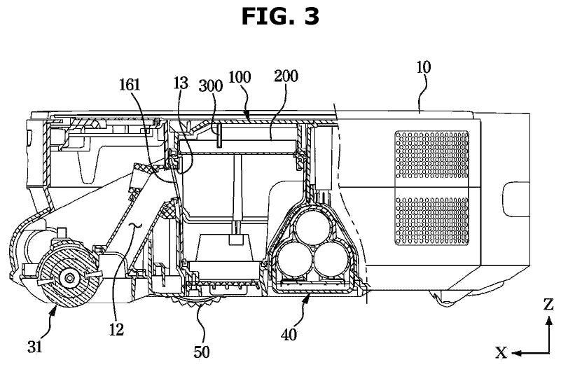

FIG. 1 is a perspective view illustrating a robot cleaner according to an embodiment of the disclosure. FIG. 2 is an exploded view of the robot cleaner shown in FIG. 1 according to an embodiment of the disclosure. FIG. 3 is a side cross-sectional view of the robot cleaner shown in FIG. 1 according to an embodiment of the disclosure.

Referring to FIGS. 1 to 3, a robot cleaner 1 may include a main body 10 and a dust container 100 detachably mounted on the main body 10.

The robot cleaner 1 may be provided to intake dust on a floor together with air while moving along the floor. The robot cleaner 1 may separate and store the dust in the intaken air, and discharge dust-removed air.

The robot cleaner 1 may include the suction device 30 provided to suck dust into the main body 10. The suction device 30 may generate a suction force to introduce dust into the dust container 100. For example, the suction device 30 may be disposed at a front end of the main body 10.

The suction device 30 may have a brush 31. The brush 31 may sweep dust on the floor. More specifically, the brush 31 may rotate to transfer dust in contact with the brush 31 to the dust container 100.

The main body 10 may include a duct 12 guiding air intaken by the suction device 30 into the dust container 100. One end of the duct 12 (a duct outlet 13 to be described later) may be connected to the dust container 100.

The robot cleaner 1 may include a main body cover 20 provided to cover an upper surface of the main body 10. The main body cover 20 may be provided to cover the upper surface of the main body 10 so that parting lines are not exposed on the upper surface of the main body 10. The main body cover 20 may improve aesthetics by not revealing unnecessary parting lines on the upper surface of the main body 10.

The dust container 100 may be detachably coupled to the main body 10. The dust container 100 may be separated from the main body 10 after the main body cover 20 is separated from the main body 10. The main body cover 20 may be coupled to the main body 10 after the dust container 100 is coupled to the main body 10.

The robot cleaner 1 may include a wheel 50 provided on the main body 10. The wheel 50 may allow the main body 10 to travel along the floor surface. For example, the wheel 50 may be provided as a pair and may be provided to rotate about a rotating axis (not shown). The wheel 50 may rotate by receiving a driving force from a drive motor (not shown). The direction of movement of the robot cleaner 1 may be adjusted according to a degree of rotation of the wheel 50.

The robot cleaner 1 may include the battery 40. The battery 40 may supply power to the main body 10 so that the main body 10 may operate wirelessly and clean the floor.

The battery 40 may be disposed adjacent to the dust container 100. The battery 40 may be disposed on the rear lower side of the dust container 100. Although not specifically shown in the drawings, the battery 40 may extend in a direction in which the rotating axis of the wheel 32 extends. In other words, the battery 40 may be elongated in a direction crossing the main body 10. For example, the battery 40 may be provided as a single battery pack and may be elongated in a direction crossing the travelling direction of the main body 10.

The battery 40 may be configured to have a substantially triangular cross section. In other words, a lower surface of the battery 40 may be configured to have a larger area than an upper surface thereof. As a result, the center of gravity of the main body 10 may be placed closer to the lower surface of the main body 10, so that the main body 10 may move stably.

As described above, because the battery 40 is disposed adjacent to the dust container 100 and the cross section of the battery 40 may be provided to have a substantially triangular shape, one side of the dust container 100 adjacent to the battery 40 may be inclined to correspond to the shape of the battery 40. In other words, the dust container 100 may be provided in a shape (an inclined surface 111 to be described later) in which one side is inclined, rather than in a rectangular parallelepiped shape. This is a method for maximizing the use of space within the main body 10 and is intended to increase the capacity of the dust container 100.

The dust container 100 may be disposed behind the suction device 30. The dust container 100 may be disposed between the pair of wheels 50. The dust container 100 may be disposed in front of the battery 40.

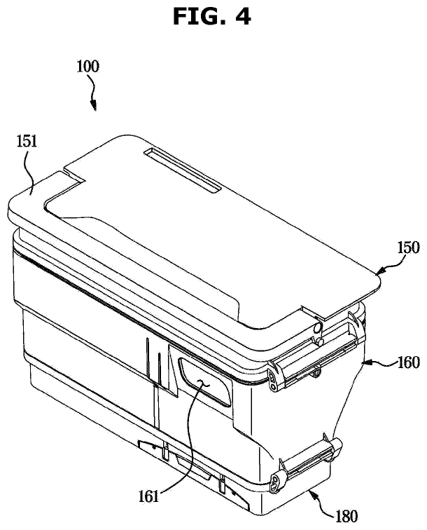

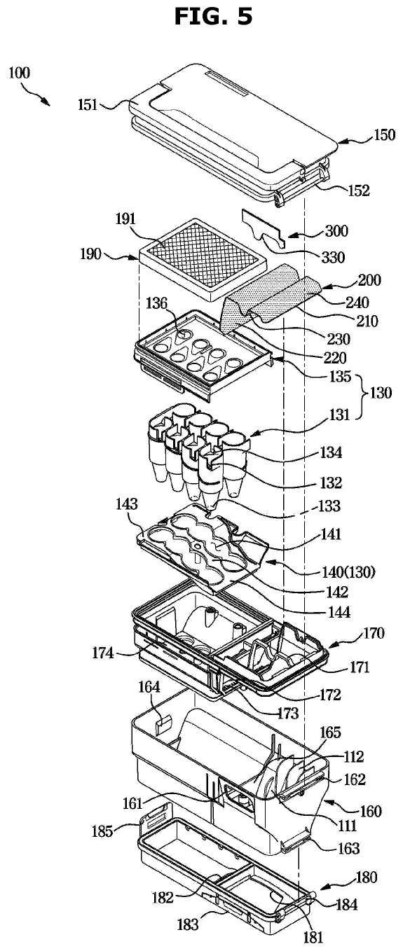

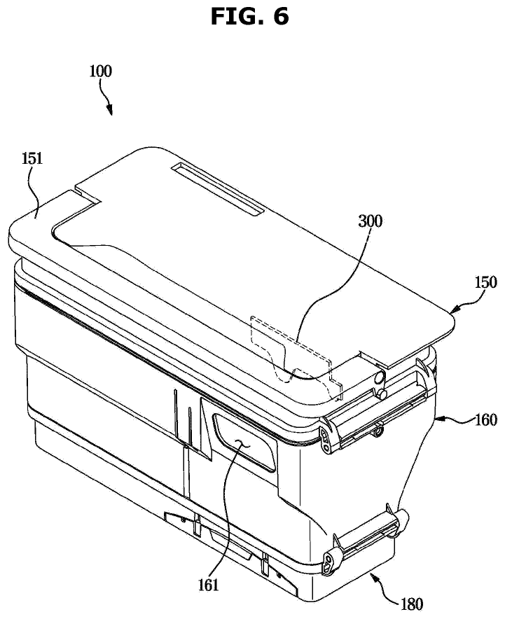

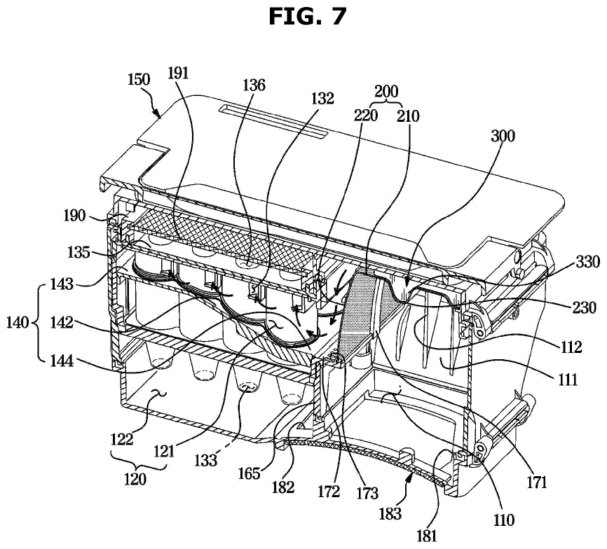

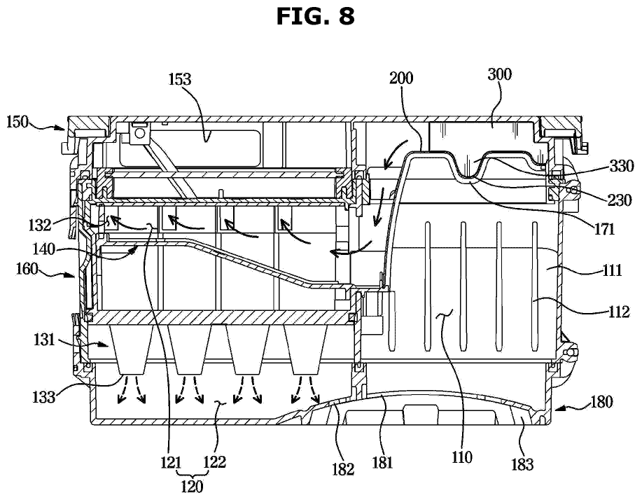

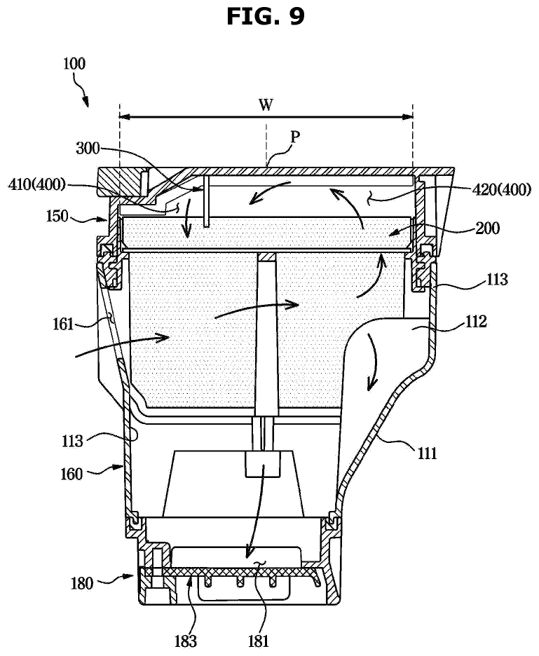

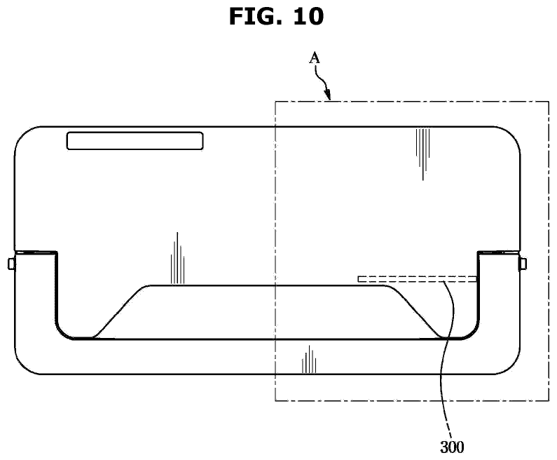

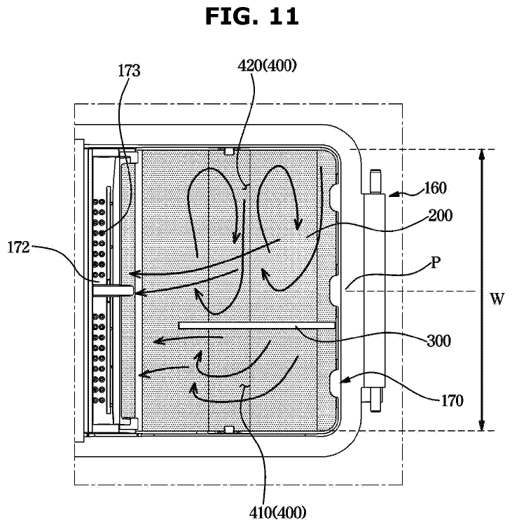

FIG. 4 is a view of the dust container of the robot cleaner shown in FIG. 2 according to an embodiment of the disclosure. FIG. 5 is an exploded view of the dust container shown in FIG. 4 according to an embodiment of the disclosure. FIG. 6 is a view illustrating an airflow guide of the dust container shown in FIG. 4 according to an embodiment of the disclosure. FIG. 7 is a view illustrating an inside of the dust container shown in FIG. 4 according to an embodiment of the disclosure. FIG. 8 is a cross-sectional view of the dust container shown in FIG. 4 according to an embodiment of the disclosure. FIG. 9 is a cross-sectional view of the dust container shown in FIG. 4 according to an embodiment of the disclosure. FIG. 10 is a plan view of the dust container shown in FIG. 4 according to an embodiment of the disclosure. FIG. 11 is a view illustrating an inside of the dust container of part A shown in FIG. 10 according to an embodiment of the disclosure.

Hereinafter, the configuration of the dust container 100 will be described in detail with reference to FIGS. 4 to 11.

The dust container 100 may include a case 160. The case 160 may have open upper and lower surfaces. The dust container 100 may include an upper cover 150 provided to cover the open upper surface of the case 160 and a lower cover 180 provided to cover the open lower surface of the case 160.

The case 160 may include an inlet 161, when the case 160 is mounted on the main body 10, through which air moved along the duct 12 by the suction device 30 is introduced. The inlet 161 may be provided to correspond to the duct outlet 13 formed at the end of the duct 12.

The case 160 may include a partition wall 165 partitioning a first chamber 110 and a second chamber 120 to be described later. For example, the partition wall 165 may be formed to extend upward from a lower end of the case 160. The partition wall 165 may extend in a direction parallel to a direction in which air is introduced through the inlet 161.

The case 160 may include a first shaft coupling part 162 to which an upper shaft 152 of the upper cover 150 is detachably coupled. The case 160 may include a second shaft coupling part 163 to which a lower shaft 184 of the lower cover 180 is detachably coupled. The upper cover 150 may be rotatably coupled to the case 160 by coupling the upper shaft 152 to the first shaft coupling part 162. The lower cover 180 may be rotatably coupled to the case 160 by coupling the lower shaft 184 to the second shaft coupling part 163. In addition, the case 160 may further include a locking groove 164 provided to maintain a state in which the upper cover 150 covers the open upper surface of the case 160.

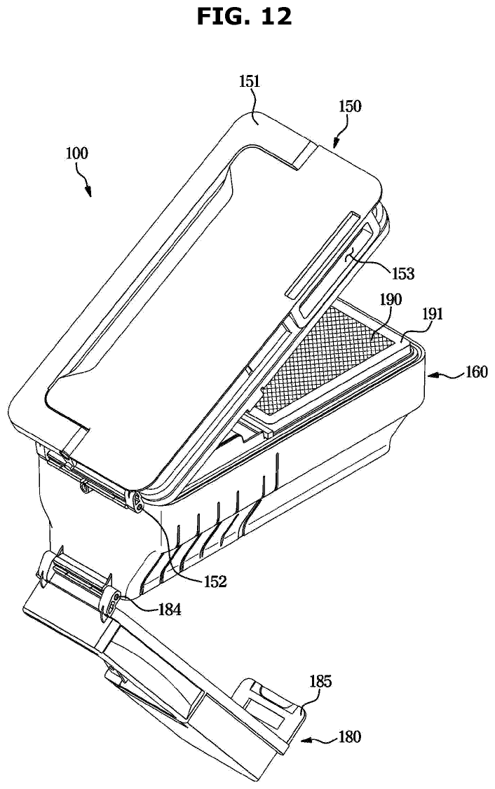

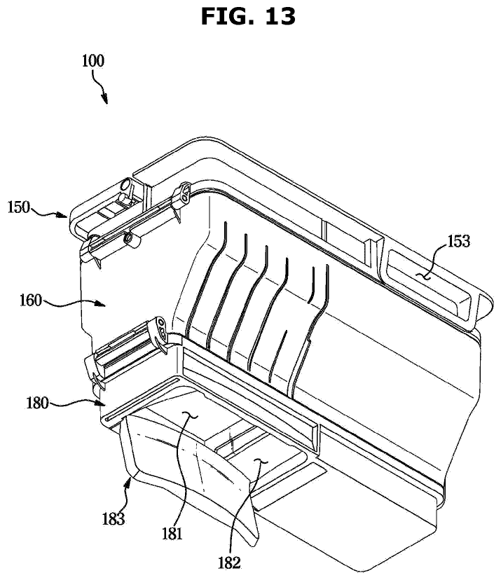

FIG. 12 is a view illustrating a state in which upper and lower covers of the dust container shown in FIG. 4 are opened according to an embodiment of the disclosure. FIG. 13 is a view illustrating a state in which a discharge port door of the dust container shown in FIG. 4 is opened according to an embodiment of the disclosure.

The upper cover 150 may be detachably coupled to the case 160. The upper cover 150 may also be rotatably provided on the case 160. The upper cover 150, rotating with respect to the case 160, may allow the upper surface of the case 160 to be opened or closed without being separated from the case 160.

A handle 151 may be provided on the upper cover 150 to allow a user to hold the dust container 100. The handle 151 may allow the user to easily mount and/or dismount the dust container 100 from the main body 10 through the handle 151.

The upper cover 150 may include an outlet 153 through which air introduced into the dust container 100 is discharged to the outside of the dust container 100. Air from which dust has been removed may be discharged to the outside of the dust container 100 through the outlet 153.

The lower cover 180 may be detachably coupled to the case 160. The lower cover 180 may also be rotatably provided on the case 160. The lower cover 180, rotating with respect to the case 160, may allow the lower surface of the case 160 to be opened or closed without being separated from the case 160.

The lower cover 180 may include dust outlets 181 and 182. The dust outlets 181 and 182 may include a first dust outlet 181 and a second dust outlet 182. The first dust outlet 181 may be provided to discharge dust stored in the first chamber 110. The second dust outlet 182 may be provided to discharge dust stored in the second chamber 120.

The lower cover 180 may include an outlet door 183 provided to open and close the first dust outlet 181 and the second dust outlet 182 (see FIG. 13). For example, the outlet door 183 opens the first dust outlet 181 and the second dust outlet 182 together to simultaneously discharge the dust stored in the first chamber 110 and the second chamber 120.

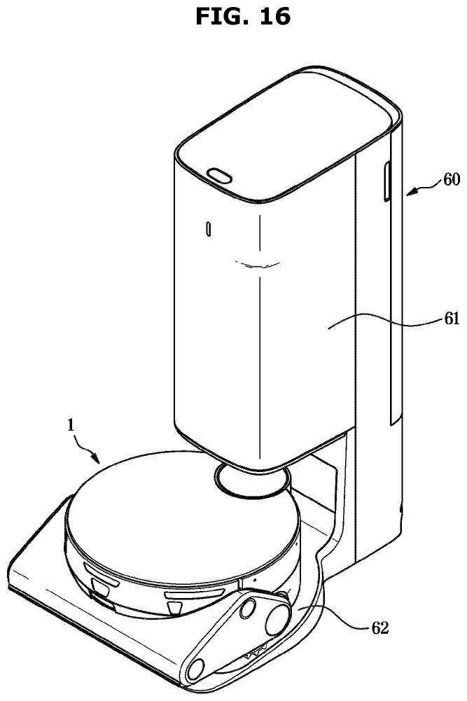

When the robot cleaner 1 is docked to a docking station 60, the dust stored in the dust container 100 may be discharged to the docking station 60 through the first dust outlet 181 and the second dust outlet 182 (see FIG. 16). If the user desires to discharge the dust inside the dust container 100 directly, the dust may be easily removed by opening the lower cover 180 (see FIG. 12).

The lower cover 180 may further include a locking portion 185 coupled to the case 160 such that the lower cover 180 keeps the lower surface of the case 160 closed.

The upper cover 150 and the lower cover 180 may be rotatably provided with respect to the case 160, respectively (see FIG. 12). More specifically, the upper cover 150 may rotate with respect to the case 160 about the upper shaft 152. The lower cover 180 may rotate with respect to the case 160 about the lower shaft 184.

The dust container 100 may include a support 170 detachably coupled to the inside of the case 160. The dust container 100 may include a dust collecting cover 200 and a filter 191, respectively, coupled to the support 170. The dust collecting cover 200 may be provided to filter relatively large dust from the air introduced into the first chamber 110. The filter 191 may be provided to filter dust that is not filtered from the first chamber 110 and the second chamber 120, which will be described later.

The support 170 may be provided to be coupled to the inside of the case 160. The support 170 may be provided to support a cyclone device 130, which will be described later. The support 170 may include a dust collecting cover support 171 provided to support the dust collecting cover 200. The support 170 includes an extension 172 coupled to the case 160 and extending from the partition wall 165 toward the first chamber 110, and a plurality of cyclone holes 173 formed in the extension 172. In addition, a cyclone lower cover 174 may be coupled to the support 170. The cyclone lower cover 174 may be provided to partition the second chamber 120.

The cyclone device 130 may include a cyclone separator 131. The cyclone device 130 may include a cyclone holder 140 provided to support the cyclone separator 131. The cyclone device 130 may include a cyclone upper cover 135 provided to cover a top of the cyclone separator 131.

The cyclone device 130 may include a plurality of cyclone separators 131. For example, the cyclone device 130 may include eight cyclone separators 131 arranged in a 2×4 shape, but is not limited thereto. The cyclone separator may be provided in different numbers, including one.

The cyclone separator 131 may have a conical shape with open upper and lower surfaces. The cyclone separator 131 may include a cyclone inlet 132 through which air is introduced. The cyclone separator 131 may include a cyclone dust outlet 133 through which dust separated from air introduced into the cyclone separator 131 is discharged. The cyclone separator 131 may include a cyclone outlet 134 through which air is discharged from the inside of the cyclone separator 131. For example, the cyclone inlet 132 may be formed at an upper end of the side of the cyclone separator 131, the cyclone outlet 134 may be disposed toward the open upper surface of the cyclone separator 131, and the cyclone dust outlet 133 may be disposed toward the open lower surface of the cyclone separator 131.

The dust container 100 may include the cyclone holder 140. The cyclone holder 140 may be coupled to the cyclone separator 131 to guide dust that has not flowed into the cyclone separator 131 into the cyclone hole 173.

The cyclone holder 140 may include coupling holes 141 into which the cyclone separator 131 is inserted. In addition, the cyclone holder 140 may include a holder inclined surface 142 and an upper end 143 and a lower end 144 provided at opposite ends of the holder inclined surface 142, respectively. The holder inclined surface 142 may be provided with a downward slope from the upper end 143 to the lower end 144. The lower end 144 may be provided to be connected to the extension 172 of the support 170. The dust that has accumulated in a dust separation chamber 121 of the second chamber 120, which will be described later, may be guided to the extension 172 of the supporter 170 by the holder inclined surface 142. The dust that has been guided to the extension 172 by the cyclone holder 140 may move to the first chamber 110 through the cyclone hole 173. The dust that has moved to the first chamber 110 may be discharged to the outside of the dust container 100 through the first dust outlet 181 together with the dust stored in the first chamber 110.

The cyclone upper cover 135 is coupled to an upper side of the cyclone separator 131 and may be provided to cover the top of the cyclone separator 131. The cyclone upper cover 135 is provided to correspond to the cyclone outlet 134 of the cyclone separator 131 and may include a cover hole 136 having a size smaller than that of the cyclone outlet 134.

A filter housing 190 accommodating the filter 191 may be coupled to the cyclone upper cover 135. The filter housing 190 accommodates the filter 191 and may be detachably coupled to the cyclone upper cover 135. The filter 191 may be of different types. For example, the filter 191 may include a micro filter or a high efficiency particulate air (HEPA) filter. The filter 191 may be provided to filter dust that is not filtered from the first chamber 110 and the second chamber 120, which will be described later. Air that has passed through the filter 191 may be discharged to the outside of the dust container 100 through the outlet 153 of the dust container 100.

At least one or more chambers 110 and 120 for separating and storing dust may be provided inside the dust container 100. More specifically, the first chamber 110 and the second chamber 120 may be provided inside the dust container 100.

The first chamber 110 may be a space accommodating air introduced from the dust container 100 through the inlet 161. The first chamber 110 may be provided to separate and store dust from air introduced through the inlet 161.

The case 160 may include an inclined surface 111 provided on the first chamber 110 and ribs 112 protruding from the inclined surface 111. For example, the inclined surface 111 and the ribs 112 may be provided on a wall 113 of the case 160 facing the inlet 161.

The second chamber 120 may be a space for receiving air introduced from the first chamber 110 in the dust container 100. The second chamber 120 may be provided to separate and store dust from air introduced through the first chamber 110.

The second chamber 120 may include a dust separation chamber 121 and a dust storage chamber 122. The dust separation chamber 121 and the dust storage chamber 122 may be provided separately from each other.

The dust separation chamber 121 may be a space into which the air passing through the first chamber 110 and/or the dust collecting cover 200 is introduced. For example, the dust separation chamber 121 may refer to a space formed in the second chamber 120 by the cyclone upper cover 135 and the cyclone holder 140, but is not limited thereto. In the case of a dust container without a cyclone holder, a dust separation chamber may be formed by a cyclone upper cover and a cyclone lower cover.

Air introduced into the dust separation chamber 121 may be introduced into the cyclone separator 131 through the cyclone inlet 132. A vortex is formed inside the cyclone separator 131, and dust in the air is separated by the centrifugal force of the vortex and then discharged through the cyclone dust outlet 133. Air introduced into the cyclone separator 131 may be discharged through the cyclone outlet 134. More specifically, the dust may be discharged to the outside of the dust separation chamber 121 through the cover holes 136 formed in the cyclone upper cover 135. Air discharged through the cover holes 136 may be discharged to the outlet 153 of the dust container 100 through the filter 191 disposed to face the cyclone upper cover 135.

Dust discharged to the lower surface of the cyclone separator 131 through the cyclone dust outlet 133 may be stored in the dust storage chamber 122 of the second chamber 120. In other words, the dust storage chamber 122 may be provided to store dust separated from air introduced into the second chamber 120. The dust storage chamber 122 may be provided under the dust separation chamber 121.

For example, the dust storage chamber 122 may be partitioned by the cyclone lower cover 174, but is not limited thereto. The cyclone lower cover 174 may be omitted, and the upper surface of the dust separation chamber 121 may be partitioned by the cyclone holder 140.

The first chamber 110 and the second chamber 120 may be arranged side by side in a first direction. The first direction may be a left-right direction (Y direction). In other words, the first chamber 110 and the second chamber 120 may be arranged side by side in the left-right direction. For example, the first chamber 110 and the second chamber 120 may be arranged in a direction parallel to the rotating axis of the wheel 50. Air introduced into the dust container 100 may flow from the first chamber 110 toward the second chamber 120.

The dust collecting cover 200 may be provided between the first chamber 110 and the second chamber 120. Air introduced into the first chamber 110 may be introduced into the second chamber 120 through the dust collecting cover 200. The dust collecting cover 200 may be provided to filter dust in the air introduced into the second chamber 120 from the first chamber 110. The dust collecting cover 200 may be provided to filter relatively large dust particles from the air introduced into the first chamber 110 of the dust container 100.

The dust collecting cover 200 may be provided to cover the top and side surfaces of the first chamber 110. More specifically, the dust collecting cover 200 may include a first cover 210 and a second cover 220. The first cover 210 may be provided to cover an upper surface of the first chamber 110. The second cover 220 may is provided to extend downwardly from the first cover 210 to cover one side of the first chamber 110 facing the second chamber 120.

The dust collecting cover 200 may include at least one bent portion 230. The bent portion 230 may be provided to increase a surface area of the dust collecting cover 200. The increase in the surface area of the dust collecting cover 200 by the bent portion 230 allows relatively large dust particles to be effectively filtered from the air introduced into the first chamber 110. For example, the bent portion 230 may extend in a front-to-back direction (X direction) along the first cover 210.

The dust collecting cover 200 may include at least one of a grille and a mesh. For example, the dust collecting cover 200 may include a plurality of holes 240 to filter dust in the air, but is not limited thereto. The dust collecting cover 200 may be configured in various shapes to filter dust.

Referring to FIGS. 3 and 5 to 10, the dust container 100 may include an airflow guide 300 for guiding air inside the dust container 100 in a predetermined direction.

The airflow guide 300 may be disposed above the dust collecting cover 200. More specifically, the airflow guide 300 may be disposed in a space between the upper surface of the dust collecting cover 200 and a lower surface 150a of the upper cover 150. The airflow guide 300 may be provided to extend in the left-right direction (Y direction), and air may flow along a direction in which the airflow guide 300 extends.

The airflow guide 300 may partition a space between the dust collecting cover 200 and the upper cover 150 to form a guide passage. For example, the guide passage may include a first region 410 and a second region 420, which will be described later.

The airflow guide 300 may include a shape corresponding to the dust collecting cover 200. For example, the airflow guide 300 may include a protrusion 330 corresponding to the bent portion 230 of the dust collecting cover 200. The airflow guide 300 may be provided to be engaged with the dust collecting cover 200. The protrusion 330 may be provided to be engaged with the bent portion 230.

The airflow guide 300 may control a flow of air within the dust container 100. More specifically, the airflow guide 300 may be provided to guide air flowing in an upper portion of the dust collecting cover 200 towards the second chamber 120. In addition, the airflow guide 300 may prevent the air, flowing from the first chamber 110 through the dust collecting cover 200 to the second chamber 120, from flowing backward to the first chamber 110.

Conventional robot cleaners do not have a separate element to guide the airflow, so it is difficult to remove dust that has accumulated in a certain region due to the structure of a dust container. In particular, in an automatic dust discharge mode, the dust inside the dust container is not properly discharged and remains inside the dust container although a dust outlet is open. Furthermore, users need to disassemble the dust container directly to remove residual dust, which causes inconvenience to the user. More specifically, air entering at high speed from the inlet of the dust container hits the wall of the case facing the inlet and creates a backflow. As a result of the backflow, some air may move to the upper portion of the dust collecting cover without escaping through the dust outlet. At this time, the air that has moved to the upper portion of the dust collecting cover may only stay and flow only in an area on the upper portion of the dust collecting cover without moving toward the cyclone device, so that a lot of dust may accumulate on the upper portion of the dust collecting cover. Consequently, the dust in the air flowing over the dust collecting cover accumulates on the upper portion of the dust collecting cover. The dust that has accumulated on the upper portion of the dust collecting cover is stuck to the dust collecting cover, and is therefore not discharged to the outside of the dust container although the dust outlet is open in the automatic dust discharge mode.

On the contrary, according to the spirit of the disclosure, the robot cleaner 1 may have the dust container 100 with an improved structure and thus the above disadvantages may be solved. In other words, the robot cleaner 1 includes the airflow guide 300 for guiding air inside the dust container 100, so that the dust remaining inside the dust container 100 may be minimized. In particular, the dust that has accumulated on the upper portion of the dust collecting cover 200 may be minimized.

More specifically, the air introduced at high speed from the inlet 161 of the dust container 100 may hit the wall 113 of the case 160 facing the inlet 161 and creates the backflow. As a result of the backflow, some air may move to the upper portion of the dust collecting cover 200. At this time, the air that has moved to the upper portion of the dust collecting cover 200 may be guided toward the second chamber 120 through the airflow guide 300. More specifically, the air above the dust collecting cover 200 may rotate and flow toward the second chamber 120 when it collides with the airflow guide 300. In other words, as the airflow guide 300 guides the air flowing in the upper portion of the dust collecting cover 200, the accumulation of dust on the upper portion of the dust collecting cover 200 may be minimized.

On the other hand, referring to FIGS. 9 and 11, the airflow guide 300 may be disposed adjacent to the suction device 30 based on a direction (first direction) in which the first chamber 110 and the second chamber 120 are arranged side by side and a second direction in which the first chamber 110 and the second chamber 120 intersect each other. In particularly, the airflow guide 300 may be located closer to the suction device 30 than a point P corresponding to approximately ½ of a width W of the dust container 100 in the front-to-back direction (X direction) and may furthermore be located closer to the inlet 161 than the point P. Such a positional feature of the airflow guide 300 may be due to the following reasons.

Referring to FIGS. 9 and 11, in an upper space 400 of the dust collecting cover 200, a region located in front of the airflow guide 300 may be defined as the first region 410, and a region located at a rear of the airflow guide 300 may be defined as the second region 420. The first region 410 may be a region relatively close to the inlet 161, and the second region 420 may be a region relatively far from the inlet 161.

Of the air flowing in the upper space 400 of the dust collecting cover 200, the air from the second region 420 toward the first region 410 (i.e., the air flowing forward in the upper space 400) hits the airflow guide 300. The air hitting the airflow guide 300 turns around and flows toward the second chamber 120. In other words, the airflow guide 300 may induce the air toward the second chamber 120 by preventing the air from flowing from the second region 420 to the first region 410.

At this time, the airflow guide 300 disposed closer to the inlet 161 than the point P allows an amount of air flowing from the second region 420 to the first region 410 to be reduced. In other words, the amount of air flowing forwardly in the upper space 400 of the dust collecting cover 200 may be reduced. Accordingly, the accumulation of dust in an upper region (i.e., corresponding to the first region 410) of the dust collecting cover 200, which is adjacent to the inlet 16, may be minimized. The first region 410 is a region adjacent to the inlet 161, so that the dust in the air flowing in the first region 410 is introduced into the first chamber 110 by the rapid airflow on the side of the inlet 161. Accordingly, when the amount of dust accumulated in the first region 410 is small, the dust accumulated in the first region 410 may be easily reintroduced into the first chamber 110. In other words, when the amount of dust accumulated in the first region 410 is minimized, the accumulation of dust may be most effectively prevented. As a result, the airflow guide 300 may be disposed closer to the inlet 161 than the point P in order to minimize the residual dust in the first region 410.

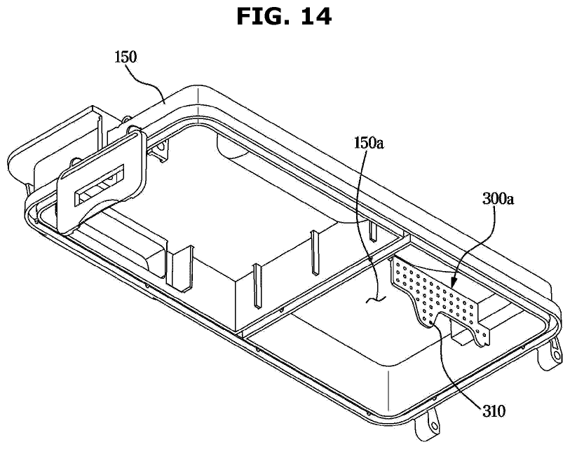

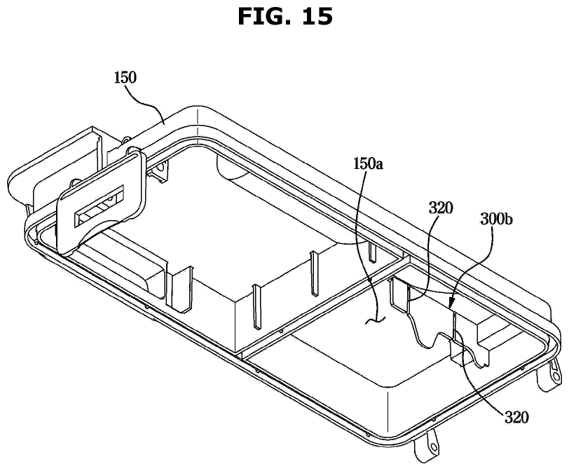

FIG. 14 is a view illustrating an airflow guide of a robot cleaner according to an embodiment of the disclosure. FIG. 15 is a view illustrating an airflow guide of a robot cleaner according to an embodiment of the disclosure.

Airflow guides 300, 300a, and 300b may be integrally formed with the upper cover 150. For example, the airflow guide 300 may extend downwardly from the lower surface 150a of the upper cover 150.

Referring to FIG. 14, the airflow guide 300a may include a through-hole 310. The through-hole 310 may be provided in plurality. Referring to FIG. 15, the airflow guide 300b may include a slot 320. The slot may be provided in plurality and may extend in a vertical direction (Z direction). The airflow guide 300 may prevent air from remaining on the upper portion of the dust collecting cover 200 by including the through-holes 310 and/or the slots 320. Accordingly, the accumulation of dust may be effectively prevented.

FIG. 16 is a view illustrating a state in which the robot cleaner shown in FIG. 1 is seated in a docking station according to an embodiment of the disclosure.

Referring to FIG. 16, the robot cleaner 1 may further include the docking station 60. The docking station 60 may be provided to be docked with the main body 10 to charge the battery 40 (see FIG. 3) located within the main body 10, and to discharge dust stored in the dust container 100.

The docking station 60 may include a station housing 61 having a predetermined space formed therein and a cleaner seat 62 in which the main body 10 of the robot cleaner 1 is seated.

The station housing 61 may accommodate at least a part of a collection device (not shown) for collecting dust and the like collected by the robot cleaner 1. The station housing 61 may accommodate electrical components for charging the battery 40 of the robot cleaner 1. The cleaner seat 62 may be provided to seat the main body of the robot cleaner 1 and may support a lower portion of the station housing 61.

The docking station 60 may discharge dust stored in the dust container 100 through dust outlets 181 and 182 (see FIG. 9) formed at a lower portion of the dust container 100. For example, a dust collection passage (not shown) may be provided inside the docking station 60, and the dust collection passage may communicate with the dust outlets 181 and 182 of the dust container 100.

More specifically, when the robot cleaner 1 is seated on the cleaner seat 62 of the docking station 60, the automatic dust discharge mode may be performed. For example, in the automatic dust discharge mode, as the outlet door 183 of the dust container 100 is open, the dust stored in the dust container 100 may move to a dust collection passage (not shown) of the docking station 60 communicating with the dust outlets 181 and 182. In other words, the dust stored in the first chamber 110 and the second chamber 120 of the dust container 100 may be automatically emptied by the automatic dust discharge mode of the robot cleaner 1. Therefore, the user does not need to empty the dust in the dust container 100.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A robot cleaner, comprising:
a main body including a suction device configured to intake dust; and
a dust container detachably mounted on the main body and configured to separate and store dust from air intaken by the suction device;
wherein the dust container comprises:
a first chamber configured to separate and store dust from air introduced from the suction device,
a second chamber configured to separate and store dust from air introduced from the first chamber,
a dust collecting cover configured to filter dust in air introduced from the first chamber into the second chamber, and
an airflow guide disposed on an upper portion of the dust collecting cover and configured to guide air flowing above the upper portion of the dust collecting cover toward the second chamber.

2. The robot cleaner of claim 1, wherein the airflow guide is located closer to the suction device than a point of ½ of a width of the dust container in a front-to-back direction.

3. The robot cleaner of claim 1, wherein the first chamber and the second chamber are arranged side by side in a left-right direction.

4. The robot cleaner of claim 1, wherein the dust collecting cover further comprises:
a first cover configured to cover an upper surface of the first chamber, and
a second cover extending downwardly from the first cover and configured to cover one side of the first chamber facing the second chamber.

5. The robot cleaner of claim 4, wherein the first cover of the dust collecting cover includes at least one bent portion to increase a surface area of the dust collecting cover.

6. The robot cleaner of claim 1, wherein the dust collecting cover includes at least one of a grille or a mesh.

7. The robot cleaner of claim 1, further comprising:
a cyclone separator disposed in the second chamber and configured to separate dust in air introduced into the second chamber by using centrifugal force of a vortex,
wherein the cyclone separator comprises:
a cyclone inlet disposed on a side surface of the cyclone separator to allow air to flow into the cyclone separator,
a cyclone dust outlet disposed on a lower surface of the cyclone separator to allow dust separated from air introduced into the cyclone inlet to be discharged, and
a cyclone outlet disposed on an upper surface of the cyclone separator to allow dust-separated air after being introduced into the cyclone inlet to be discharged.

8. The robot cleaner of claim 1, wherein the dust container further comprises:
a case having an open upper surface and an open lower surface and configured to form the first chamber and the second chamber,
an upper cover configured to cover the open upper surface of the case, and
a lower cover configured to cover the open lower surface of the case and including a dust outlet for discharging dust stored in the first chamber and the second chamber.

9. The robot cleaner of claim 8, wherein the airflow guide is integrally formed with the upper cover, and configured to partition a space between the dust collecting cover and the upper cover to form a guide passage.

10. The robot cleaner of claim 1, wherein the airflow guide extends in a left-right direction.

11. The robot cleaner of claim 1, wherein the second chamber further comprises:
a dust separation chamber into which air passing through a dust collecting chamber is introduced, and
a dust storage chamber partitioned from the dust separation chamber and disposed at a lower portion of the dust separation chamber to store dust separated from the air passing through the dust collecting chamber in the dust separation chamber.

12. The robot cleaner of claim 1, wherein the dust container further comprises:
a first dust outlet disposed at a lower portion of the first chamber to allow dust in the first chamber to be discharged,
a second dust outlet disposed at a lower portion of the second chamber to allow dust in the second chamber to be discharged, and
an outlet door configured to open and close the first dust outlet and the second dust outlet.

13. The robot cleaner of claim 1, further comprising:
a docking station configured to seat the main body,
wherein the docking station is configured to charge a battery mounted inside the main body and automatically discharge dust stored in the dust container.
